(19) United States
(12) Patent Application Publication
(10) Pub. No.: US 2023/0234020 A1
(43) Pub. Date: Jul. 27, 2023

(54) MICROWAVE PLASMA DEVICE WITH INCREASED SELECTIVITY OF NITROGEN OXIDE AND METHOD OF PRODUCING NITROGEN OXIDE-CONTAINING WATER USING SAME

(71) Applicant: KOREA INSTITUTE OF FUSION ENERGY, Daejeon (KR)

(72) Inventors: Yong Cheol HONG, Goyang-si (KR); Se Min CHUN, Gunsan-si (KR); Geon Woo YANG, Gunsan-si (KR); Hee Jae LEE, Gunsan-si (KR)

(21) Appl. No.: 18/010,912

(22) PCT Filed: May 25, 2021
(86) PCT No.: PCT/KR2021/006482

§ 371 Date: Dec. 16, 2022

(30) Foreign Application Priority Data
Jun. 26, 2020 (KR) 10-2020-0078677

(51) Int. Cl. B01J 19/12; C01B 21/20; H05H 1/46

(52) U.S. Cl. CPC B01J 19/126; C01B 21/203; H05H 1/461; B01J 2219/0898; B01J 2219/1239; B01J 2219/1227; H05H 2245/10

(57) ABSTRACT

Provided is a microwave plasma device, including: a hollow tube that is hollow and irradiated with a microwave; a swirl gas inlet that is located at a lower end portion of the hollow tube and injected with a swirl gas; an axial gas inlet that penetrates through the lower end portion of the hollow tube and injected with an axial gas; and a swirl gas barrier that is located inside the hollow tube, located near where the swirl gas is injected, and extends in a longitudinal direction of the hollow tube, in which a gap g is formed between the swirl gas barrier and the hollow tube, and plasma is generated inside the hollow tube and nitrogen oxide is generated inside the hollow tube.

### TECHNICAL FIELD

The present invention relates to a microwave plasma device with increased selectivity of nitrogen oxide and a method of producing nitrogen oxide-containing water using the same.

### BACKGROUND ART

Since R. F. Furchgott, L. J. Ignarro, and F. Murad received the Nobel Prize in 1998 for discovering that nitric oxide (NO), among nitrogen oxides, plays a role as a signaling molecule in living cells, interest in nitric oxide has spread rapidly in the academic world. Many benefits of nitric oxide have now been discovered in animals and plants.

In particular, since nitric oxide has the ability to activate cells, when nitric oxide-containing water is periodically applied to a wound area, the wound area may be quickly regenerated and healed. For example, when the wound area is exposed to nitric oxide-containing water, the wound surface is washed and microorganisms attached to or parasitic on the wound surface are sterilized. In addition, thread veins are expanded, blood circulation is good, cell proliferation is active, and protein proliferation is good. Therefore, macrophages increase a lot in the wound area and fibroblasts proliferate quickly, enabling rapid wound healing.

In order to produce nitrogen oxide-containing water such as nitric oxide, research on technologies capable of appropriately generating and controlling nitrogen oxide is being conducted.

Conventionally, research on generating nitrogen oxide using a microwave plasma device has been conducted. However, the conventional device has low selectivity for nitrogen oxides such as nitric oxide or nitrogen dioxide. In particular, due to a turbulent flow of axial gas on a wall surface of a dielectric tube (hollow tube), a nitrogen oxide conversion rate of the axial gas is low. In addition, in the case of aerosols or particles with a large mass, the occurrence of the turbulent flow may be more severe.

### DISCLOSURE

### Technical Problem

The present invention has been made in an effort to provide a device having a microwave plasma nozzle with high selectivity of nitrogen oxide.

In addition to the above problems, exemplary embodiments according to the present invention may be used to achieve other problems not specifically mentioned.

### Technical Solution

An exemplary embodiment of the present invention provides a microwave plasma device, including: a hollow tube that is hollow and irradiated with a microwave; a swirl gas inlet that is located at a lower end portion of the hollow tube and injected with a swirl gas; an axial gas inlet that penetrates through the lower end portion of the hollow tube and injected with an axial gas; and a swirl gas barrier that is located inside the hollow tube, located near where the swirl gas is injected, and extends in a longitudinal direction of the hollow tube, in which a gap g is formed between the swirl gas barrier and the hollow tube, and plasma is generated inside the hollow tube and nitrogen oxide is generated inside the hollow tube.

The swirl gas may pass through the gap g and may be supplied to the inside of the hollow tube.

The swirl gas may be oxygen or nitrogen

When the swirl gas is oxygen, the axial gas may be nitrogen, and when the swirl gas is nitrogen, the axial gas may be oxygen.

Another embodiment of the present invention provides a method of producing nitrogen oxide, including: injecting a swirl gas into a hollow tube; passing the injected swirl gas through a gap formed between a swirl gas barrier and the hollow tube; injecting an axial gas into the hollow tube; irradiating a microwave to the hollow tube; and generating plasma inside the hollow tube and generating nitrogen oxide gas.

Yet another embodiment of the present invention provides a method of producing nitrogen oxide-containing water, including: injecting a swirl gas into a hollow tube; passing the injected swirl gas through a gap formed between a swirl gas barrier and the hollow tube; injecting an axial gas into the hollow tube; irradiating a microwave to the hollow tube; generating plasma inside the hollow tube and generating nitrogen oxide gas; and plasma-treating the generated nitrogen oxide gas to distilled water to produce nitrogen oxide-containing water.

The method may further include removing oxygen, which is a dissolved gas, from the nitrogen oxide-containing water.

The method may further include cooling and storing the nitrogen oxide-containing water.

### Advantageous Effects

According to an embodiment of the present invention, it is possible to increase the selectivity of nitrogen oxides and a nitrogen oxide conversion rate in an axial gas may be high.

### DESCRIPTION OF THE DRAWINGS

FIG. 1 is a side view schematically showing a microwave plasma device.

FIG. 2 is a cross-sectional view schematically showing a swirl gas inlet of a microwave plasma device.

FIG. 3 is a graph showing a magnitude of circumferential velocity (/ms⁻¹) of plasma inside the microwave plasma device.

FIG. 4 is a graph showing a mass fraction of argon inside hollow tubes of a third microwave plasma device s-4 (left) and a fifth microwave plasma device s-8 (right) of FIG. 3.

FIG. 5 is a graph showing a pressure profile in a cross-sectional direction inside a hollow tube of the microwave plasma device according to the presence or absence of a swirl gas barrier.

FIG. 6 is a graph showing a concentration of nitrogen oxide generated in the microwave plasma device according to the presence or absence of the swirl gas barrier.

FIG. 7 is a graph showing the concentration of nitrogen oxide generated in the microwave plasma device according to the presence or absence of the swirl gas barrier with respect to a change in flow-rate of oxygen when nitrogen is used as the swirl gas and oxygen is used as the axial gas.

FIG. 8 is a graph showing the concentration of nitrogen oxide generated in the microwave plasma device according to the presence or absence of the swirl gas barrier with respect to a change in flow-rate of nitrogen when oxygen is used as the swirl gas and nitrogen is used as the axial gas.

### MODE FOR INVENTION

Hereinafter, exemplary embodiments of the present invention will be described in detail with reference to the accompanying drawings so that those skilled in the art to which the present invention pertains may easily practice the present invention. As those skilled in the art would realize, the described embodiments may be modified in various different ways, all without departing from the spirit or scope of the present invention. In order to clearly explain the present invention in the drawings, parts irrelevant to the description are omitted, and the same reference numerals are used for the same or similar components throughout the specification. In addition, in the case of a well-known known technology, a detailed description thereof will be omitted.

Throughout the specification, unless explicitly described to the contrary, the word “comprise” and variations such as “comprises” or “comprising”, will be understood to imply the inclusion of stated elements but not the exclusion of any other elements.

Then, a microwave plasma device according to an exemplary embodiment will be described in detail.

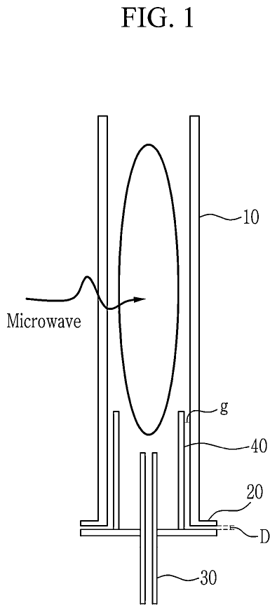

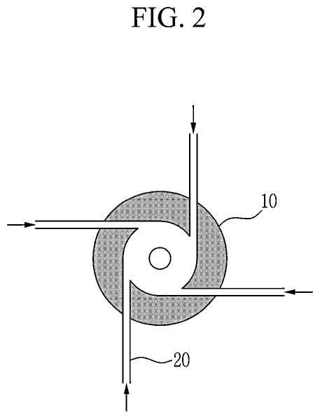

FIG. 1 is a side view schematically showing a microwave plasma device, and FIG. 2 is a cross-sectional view schematically showing a swirl gas inlet of a microwave plasma device.

Referring to FIG. 1, the microwave plasma device includes a hollow tube 10, a swirl gas inlet 20, an axial gas inlet 30, and a swirl gas barrier 40.

Here, the microwave plasma device generates plasma at normal pressure (atmospheric pressure). The normal pressure (atmospheric pressure) plasma has very different characteristics due to various electrode structures, driving frequencies, and conditions, and has various advantages such as high temperature as well as low temperature processing, high active species density, and fast processing time.

The hollow tube 10 has a hollow cylindrical shape, and is irradiated with microwaves. When microwaves are irradiated into the hollow tube 10, plasma using a swirl gas and an axial gas injected into the hollow tube 10 as a source gas is generated. For example, the hollow tube 10 may be made of quartz.

The swirl gas inlet 20 is located in a lower end portion of the hollow tube 10 and the number of swirl gas inlets 20 may be one or more. For example, referring to FIG. 2, the number of swirl gas inlets 20 is four, and the swirl gas inlets are formed along a circumference of the hollow tube 10 at an angle of about 90°. The swirl gas is spirally injected into the hollow tube 10 through the swirl gas inlet 20. For example, oxygen, nitrogen, etc., may be used as the swirl gas.

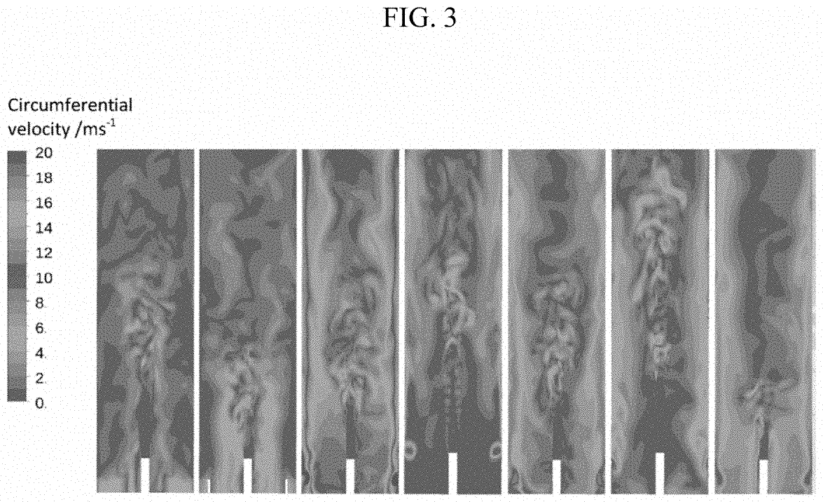

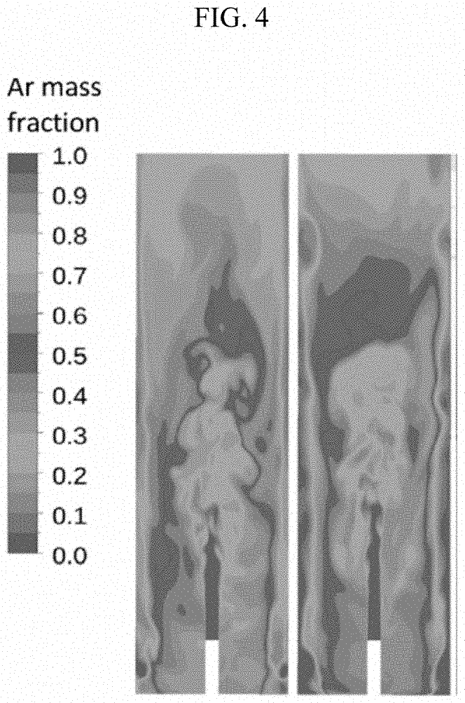

The number and shape of swirl gas inlets 20 may be optimized by experiments shown in FIGS. 3 and 4.

FIG. 3 is a graph showing a magnitude of circumferential velocity (/ms⁻¹) of plasma inside seven types of microwave plasma devices. From the left, the microwave plasma devices s-1, s-2, and s-4 in which the number of swirl gas inlets is one, two, and four are shown in order. For example, two swirl gas inlets of a second microwave plasma device s-2 form an angle of 180° to each other on the circumference. The four swirl gas inlets of the third microwave plasma device s-4 form an angle of 90° to each other on the circumference. The fourth microwave plasma device s-4_45 has four swirl gas inlets, and all the four swirl gas inlets are inclined at an angle of 45° from the axial direction. A fifth microwave plasma device s-8 has eight swirl gas inlets and forms an angle of 45° to each other on the circumference, a sixth microwave plasma device s-8_45 has eight swirl gas inlets, and all the eight swirl gas inlets are inclined at an angle of 45° from the axial direction. A seventh microwave plasma device s-12 has 12 swirl gas inlets, and form an angle of 30° to each other on the circumference.

Referring to FIG. 3, in order to measure the effect of coaxial co-flow in stability of a plasma flow field, the circumferential velocity inside the hollow tube is measured. It is most stable at the hollow tube wall and least stable near the center of the hollow tube. Accordingly, the hollow tube walls may be protected, and a precursor/carrier gas may proceed while not being hindered by a sheath gas.

In the seven plasma devices in FIG. 3, the plasma device with the best swirl flow is the third microwave plasma device (four swirl gas inlets) s-4 and the fifth microwave plasma device (eight swirl gas inlets) s-8. In the third microwave plasma device s-4, four swirl gas inlets may create an excellent spin flow with high circumferential velocity near the hollow tube wall, but in the fourth microwave plasma device s-4_45, a configuration in which the four swirl gas inlets are tilted 45° from the axial direction provides downward spin with much lower circumferential velocity. In the fifth microwave plasma device s-8, eight swirl gas inlets exhibit high circumferential velocity in the hollow tube wall, so the co-flow gas has excellent swirl.

FIG. 4 is a graph showing a mass fraction of argon inside hollow tubes of a third microwave plasma device s-4 (left) and a fifth microwave plasma device s-8 (right) of FIG. 3.

Since the circumferential velocity of the third microwave plasma device s-4 is higher than that of the fifth microwave plasma device s-8, more carrier gas is dispersed. However, the fifth microwave plasma device s-8 may be the most desirable design because the protection effect of the hollow tube wall from the carrier gas is better.

The axial gas inlet 30 is configured to pass through the center of the lower end portion of the hollow tube 10. The axial gas is injected into the hollow tube 10 through the axial gas inlet 30. For example, oxygen or nitrogen may be used as the axial gas.

In order to generate the nitrogen oxide with the microwave plasma device, a mixed gas of nitrogen and oxygen or dry air may be injected as the swirl gas. Also, nitrogen may be used as the swirl gas and oxygen may be used as the axial gas. Alternatively, oxygen may be used as the swirl gas and nitrogen may be used as the axial gas.

The swirl gas barrier 40 is formed in the vicinity of the lower portion of the hollow tube 10 into which the swirl gas is injected, and extends in the longitudinal direction of the hollow tube 10. A gap g is formed between the swirl gas barrier 40 and the inner wall of the hollow tube 10. The swirl gas injected into the swirl gas inlet 20 passes through the gap g and flows into the hollow tube 10. Due to this gap g, the nitrogen selectivity of the microwave plasma device may increase.

For example, the ratio between the gap g between the swirl gas barrier 40 and the inner wall of the hollow tube 10 and a diameter D of the swirl gas inlet 20 may satisfy Equation 1 below.

0.1≤g/D≤1.5 [Equation 1]

When the ratio of the gap (g) between the swirl gas barrier 40 and the inner wall of the hollow tube 10 and the diameter D of the swirl gas inlet 20 is greater than 1.5, since the injection of the swirl gas becomes off-tangential, the swirl flow is broken and may become a turbulent flow. In addition, when the ratio of the gap g between the swirl gas barrier 40 and the hollow tube 10 and the diameter D of the swirl gas inlet 20 is smaller than 0.1, mechanical processing may be limited.

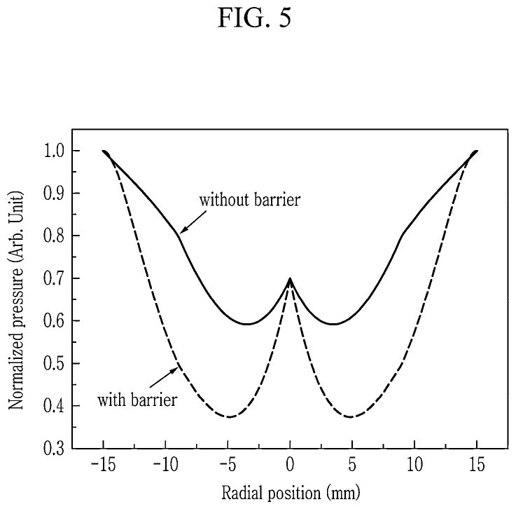

FIG. 5 is a graph showing a pressure profile in a cross-sectional direction inside the hollow tube of the microwave plasma device according to the presence or absence of the swirl gas barrier.

Referring to FIG. 5, the internal pressure decreases due to the plasma flow as the distance from the center (radial position 0 mm) of the microwave plasma device increases, and then rapidly increases as it passes a 5 mm point. In particular, it can be seen that a pressure gradient in the microwave plasma device with the swirl gas barrier is greater than that in the microwave plasma device without the swirl gas barrier.

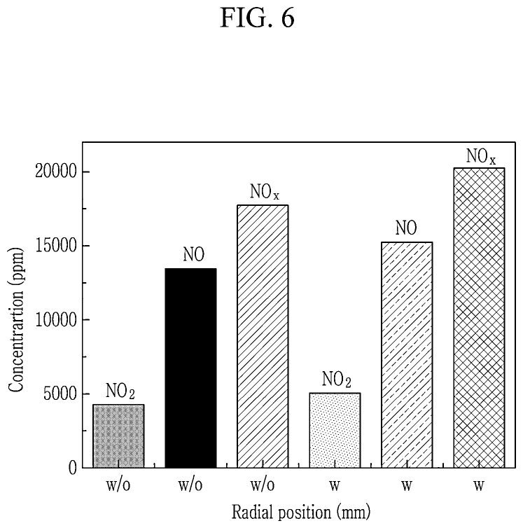

FIG. 6 is a graph showing a concentration of nitrogen oxide generated in the microwave plasma device according to the presence or absence of the swirl gas barrier.

Referring to FIG. 6, it can be seen that the concentration of nitrogen oxides NO and NO₂ generated in the microwave plasma device in the presence of the swirl gas barrier (“w”) is higher than that in the microwave plasma device in the case without the swirl gas barrier (“w/o”). Here, the concentration of NOx generated is the sum of the concentrations of NO and NO₂ generated. Under experimental conditions, g/D is 1.0, microwave power is 500 W, 15 L/min of nitrogen as the swirl gas and 0.2 L/min of oxygen as the axial gas are used.

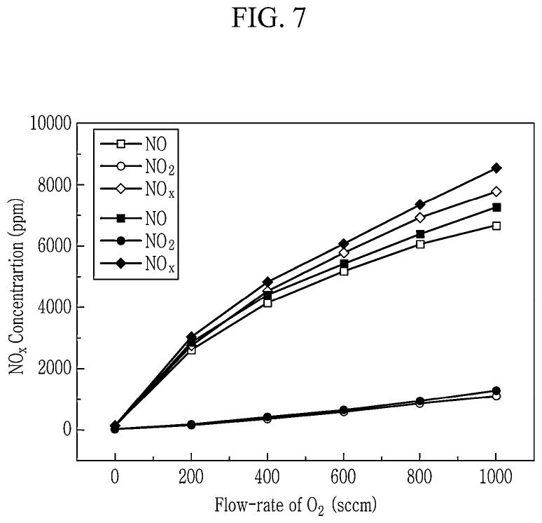

FIG. 7 is a graph showing the concentration of nitrogen oxide generated in the microwave plasma device according to the presence or absence of the swirl gas barrier with respect to a change in flow rate of oxygen when nitrogen is used as the swirl gas and oxygen is used as the axial gas.

Referring to FIG. 7, it can be seen that the concentration of nitrogen oxides NO and NO₂ generated in the microwave plasma device in the presence of the swirl gas barrier is higher than that in the microwave plasma device without the swirl gas barrier. In addition, by controlling the amount of oxygen, the selectivity of nitrogen oxides may be increased. When the generated nitrogen oxide gas passes through water, only the high-concentration nitrogen oxide gas may be obtained. Under the experimental conditions, g/D is 1.0, the microwave power is 500 W, 15 LPM of nitrogen as the swirl gas and 0-1000 sccm of oxygen as the axial gas are used.

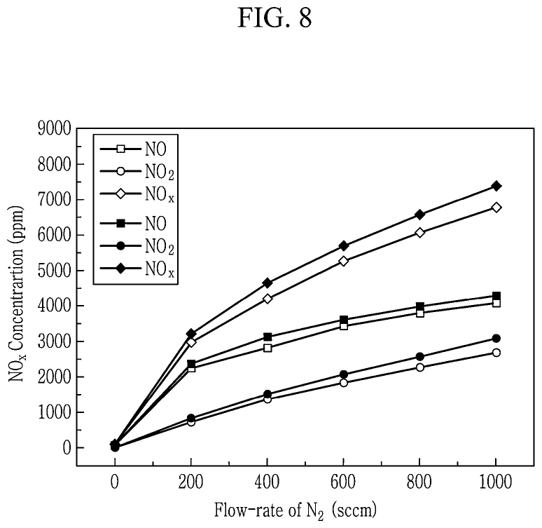

FIG. 8 is a graph showing the concentration of nitrogen oxide generated in the microwave plasma device according to the presence or absence of the swirl gas barrier with respect to a change in flow rate of nitrogen when oxygen is used as the swirl gas and nitrogen is used as the axial gas.

Referring to FIG. 8, it can be seen that the concentration of nitrogen oxides NO and NO₂ generated in the microwave plasma device in the presence of the swirl gas barrier is higher than that in the microwave plasma device without the swirl barrier. In addition, by controlling the amount of nitrogen, the selectivity of nitrogen oxides may be increased. When the generated nitrogen oxide gas passes through water, only the high-concentration nitrogen oxide gas may be obtained. Under the experimental conditions, g/D is 1.0, the microwave power is 500 W, 15 LPM of oxygen as the swirl gas and 0-1000 sccm of nitrogen as the axial gas are used.

Then, a method of producing nitrogen oxide using a microwave plasma device according to an embodiment will be described in detail.

A method of producing nitrogen oxide includes: injecting a swirl gas into a hollow tube; passing the injected swirl gas through a gap formed between a swirl gas barrier and the hollow tube; injecting an axial gas into the hollow tube; irradiating a microwave to the hollow tube; and generating plasma inside the hollow tube and generating nitrogen oxide gas.

Next, a method of producing nitrogen oxide-containing water using a microwave plasma device according to an exemplary embodiment will be described in detail.

The method of producing nitrogen oxide-containing water includes generating nitrogen oxide gas, generating nitrogen oxide water, removing oxygen which is a dissolved gas, and storing nitrogen oxide water.

The generating of the nitrogen oxide gas includes generating nitrogen oxide by the microwave plasma device according to the exemplary embodiment. Accordingly, the selectivity of nitrogen oxides is increased.

For example, a method of producing nitrogen oxide includes: injecting a swirl gas into a hollow tube; passing the injected swirl gas through a gap formed between a swirl gas barrier and the hollow tube; injecting an axial gas into the hollow tube; irradiating a microwave to the hollow tube; and generating plasma inside the hollow tube and generating nitrogen oxide gas.

Here, the microwave plasma device generates plasma at normal pressure (atmospheric pressure). The normal pressure (atmospheric pressure) plasma has very different characteristics due to various electrode structures, driving frequencies, and conditions, and has various advantages such as high temperature as well as low temperature processing, high active species density, and fast processing time.

In addition, the application fields of the atmospheric pressure plasma are very diverse, and in particular, as the atmospheric pressure plasma can perform dry processing using species having strong oxidizing power or high reactivity, the atmospheric pressure plasma may be used in the bio/medical field and food industry, such as food sterilization, bio-film removal, and organic film removal.

The generating of the nitrogen oxide water includes generating nitrogen oxide-containing water by plasma-treating the generated nitrogen oxide gas into distilled water.

Conventionally, plasma is used in wastewater treatment and post-treatment processes such as COD and BOD reduction, decolorization, and deodorization, but distilled water or solutions treated with plasma may be used in pre-treatment processes. The plasma-treated distilled water is called plasma-treated water and has good sterilization power enough to play its role as sterilization water in place of ozone water. So-called “plasma treated water” may be produced by directly or indirectly exposing distilled water to atmospheric plasma.

The atmospheric pressure plasma is discharged with various discharge gases such as helium, argon, nitrogen, etc., but the chemical species contained in the plasma treated water to be generated is determined according to the discharge gas. For example, ozone or oxygen reactive species with high sterilization power may be generated by using oxygen or a mixed gas of oxygen and other gases as a discharge gas. In addition, the chemical species dissolved in the plasma-treated water are changed according to a standing time. For example, synthetic nitrite, which is essential for producing meat products, may be replaced with the plasma-treated water. In this case, nitrite ions (Nitrite ion, NO₂⁻) and nitrate ions (NO₃⁻) contained in the plasma treated water are used as important, but since the nitrite ions decrease according to the standing time, the plasma treated water may be properly controlled.

2NO(g)+O₂(g)→2NO₂(g) [Reaction Formula 1]

NO+NO₂+H₂0→2NO₂—+2H⁺ [Reaction Formula 2]

2NO₂+H₂O→NO₂—+NO₃—+2H⁺ [Reaction Formula 3]

3NO₂(g)+H₂0( [symbol] )→2HNO₃(aq)+NO(g) [Reaction Formula 4]

4NO₂(g)+O₂(g)H₂O( [symbol] )→4HNO₃(aq) [Reaction Formula 5]

NO+OH+M→HNO₂+M [Reaction Formula 6]

NO₂+OH+M→HNO₃+M [Reaction Formula 7]

The nitrous acid dissolved in the plasma-treated distilled water has a pK value of 3.37, and 50% of the nitrous acid is dissociated in a solution of pH 3.37 to generate nitrite ions, and 99% of the nitrous acid is dissociated in a solution of pH 5.5 or higher and thus, most of the nitrous acid is dissociated to nitrite ions (Reaction Formula 8).

HONO+H2O⇄H₃O⁺+NO₂⁻ [Reaction Formula 8]

According to the stoichiometric reaction formula in which reaction equations 2 and 3 are combined, the nitrous acid undergoes intermediate chemical reactions, and finally a disproportionation occurs in which nitric oxide, nitrate ion, proton, and water are generated. That is, the nitrous acid is decomposed over time and its concentration decreases, and the decomposition rate is determined by the temperature of the solution and the initial concentration of nitrous acid. The higher the initial concentration of nitrous acid and the higher the temperature of the solution, the higher the decomposition rate is. Accordingly, as the standing time of the treated water passes, the nitrous acid decreases and at the same time, the nitrate ion increases, which is caused by the disproportionation of nitrous acid, and the Reaction Formula is as follows.

3HNO₂→2NO+NO₃⁻+H⁺+H₂O

In the step of removing oxygen which is the dissolved gas, oxygen is removed from the produced nitrogen oxide-containing water. For example, the removal of the dissolved oxygen may be performed by a vacuum method, a nitrogen blowing method, or both. The vacuum method is a method of depressurizing air using a vacuum pump. The nitrogen blow method is a method of removing oxygen from water by blowing nitrogen in the gas phase.

The concentrations of each chemical species change according to the storage period. For example, in the produced nitrogen oxide-containing water, the concentration of NO including the nitrite ions, decreases, while nitric acid ions increase. The sum of nitrous acid and nitrite ions according to the oxygen concentration present in the produced nitrogen oxide-containing water decreases with a storage period. For example, the higher the concentration of dissolved oxygen, the faster the rate of reduction of nitrous acid and nitrite ions over the storage period. When the dissolved oxygen is stored with the reduced concentration of dissolved oxygen in nitrogen oxide-containing water, the reduction rate of nitrite ions may be reduced by preventing the reduction of nitric oxide by the dissolved oxygen. When using low-temperature plasma (DBD, corona, etc.), dissolved ozone also needs to be removed.

The storing of the nitrogen oxide water includes cooling and storing the nitrogen oxide-containing water.

The cooling temperature may be between −80° C. and 20° C., and preferably, the nitrogen oxide water is cooled at a temperature between −80° C. and 0° C. Since the decomposition rate of nitrous acid is proportional to the temperature, the decomposition rate of nitrous acid and nitrite ions may be reduced when nitrogen oxide water is stored at a lower temperature.

In the nitrogen oxide-containing water, nitrite ions and nitrous acid are present in specific ratios depending on the pH of the solution, so the increase in pH (4.5-13) is required. The nitrous acid is finally decomposed into nitric oxide, nitrate ions, protons, and water by the disproportionation, and accordingly, the increase in pH (4.5-13) is required. The decomposition rate is determined by the initial concentration of nitrous acid, the storage temperature of the solution, and the concentrations of dissolved oxygen and dissolved ozone, and accordingly, the dissolved oxygen species need to be removed.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

1. A microwave plasma device, comprising:
a hollow tube that is hollow and irradiated with a microwave;
a swirl gas inlet that is located at a lower end portion of the hollow tube and injected with a swirl gas;
an axial gas inlet that penetrates through the lower end portion of the hollow tube and injected with an axial gas; and
a swirl gas barrier that is located inside the hollow tube, located near where the swirl gas is injected, and extends in a longitudinal direction of the hollow tube,
wherein a gap g is formed between the swirl gas barrier and the hollow tube, and
plasma is generated inside the hollow tube and nitrogen oxide is generated inside the hollow tube.

2. The microwave plasma device of claim 1, wherein:
the swirl gas passes through the gap (g) and is supplied to the inside of the hollow tube.

3. The microwave plasma device of claim 2, wherein:
the swirl gas is oxygen or nitrogen.

4. The microwave plasma device of claim 3, wherein:
when the swirl gas is oxygen, the axial gas is nitrogen, and when the swirl gas is nitrogen, the axial gas is oxygen.

5. A method of producing nitrogen oxide, comprising:
injecting a swirl gas into a hollow tube;
passing the injected swirl gas through a gap formed between a swirl gas barrier and the hollow tube;
injecting an axial gas into the hollow tube;
irradiating a microwave to the hollow tube; and
generating plasma inside the hollow tube and generating nitrogen oxide gas.

6. A method of producing nitrogen oxide-containing water, comprising:
injecting a swirl gas into a hollow tube;
passing the injected swirl gas through a gap formed between a swirl gas barrier and the hollow tube;
injecting an axial gas into the hollow tube;
irradiating a microwave to the hollow tube;
generating plasma inside the hollow tube and generating nitrogen oxide gas; and
plasma-treating the generated nitrogen oxide gas into distilled water to produce nitrogen oxide-containing water.

7. The method of claim 6, further comprising:
removing oxygen, which is a dissolved gas, from the nitrogen oxide-containing water.

8. The method of claim 7, further comprising:
cooling and storing the nitrogen oxide-containing water.
